(19) United States
(12) Patent Application Publication
(10) Pub. No.: US 2016/0154702 A1
(43) Pub. Date: Jun. 2, 2016

(54) METHOD OF CONTROLLING SLED PLANAR OF BLADE SERVER

(71) Applicants: Inventec (Pudong) Technology Corporation, Shanghai City (CN); INVENTEC CORPORATION, Taipei City (TW)

(72) Inventor: Chia-Hsiang CHEN, Taipei City (TW)

(21) Appl. No.: 14/678,374

(22) Filed: Apr. 3, 2015

(30) Foreign Application Priority Data
Nov. 27, 2014 (CN) 201410707252.8

(51) Int. Cl. G06F 11/14; G06F 9/44; G06F 1/32

(52) U.S. Cl. CPC G06F 11/1441; G06F 1/3287; G06F 9/442; G06F 1/3296

(57) ABSTRACT

The present invention provides a method for controlling a sled planar of a blade server including activating a chassis management system, determining whether a request sent from the chassis management system is a shutting down signal or a resetting signal, comparing whether a power measured value of a sled planar of a blade server exceeds a power threshold value when the request is the shutting down signal or the resetting signal, determining whether the chassis management system encounters a system error when the power measured value of the sled planar of the blade server does not exceed the power threshold value, and shutting down or resetting the sled planar of the blade server according to a default condition when the chassis management system does not encounter the system error.

### CROSS-REFERENCE TO RELATED APPLICATIONS

This non-provisional application claims priority under 35 U.S.C. §119(a) on Patent Application No. 201410707252.8 filed in China on Nov. 27, 2014, the entire contents of which are hereby incorporated by reference.

### BACKGROUND OF THE INVENTION

1. Technical Field of the Invention

The present invention relates to a blade server, particularly to a method for controlling the sled planar of the blade server.

2. Description of the Related Art

Please refer to FIG. 1. FIG. 1 is a diagram of a blade server in the prior art. The blade server 1 has a chassis 11 and the chassis 11 is available for being plugged into a plurality of single board computers and each single board computer hereinafter is referred to a sled planar 12. The blade server 1 provides a plurality of centralizedly and collectively installed sled planars 12 with the functions of the power supply, the heat dissipation fan, the network communication . . . etc.

However, due to the characteristic of compact assembling of the sled planar 12 in the blade server 1, it leads to a higher demand of power supply and heat dissipation. Furthermore, the blade server 1 manages and distributes the resources to a plurality of sled planars 12 of the blade server 1 by the chassis management system. Therefore, when managing and distributing the resources, if a system error occurs, such as shutting down or resetting, a wrong operation is performed to the system of the blade server 1 resulting in shutting down or resetting the system, and the chassis management system does not anticipate this kind of error.

Owing to the problem, how to find a method for adequately distributing the resources of the blade server and determining the signals of the chassis management system is an urgent problem in the industry.

### SUMMARY OF THE INVENTION

One or more exemplary embodiment in the present invention provides a method for controlling a sled planar of a blade server including activating a chassis management system, determining whether a request sent from the chassis management system is a shutting down signal or a resetting signal, comparing whether a power measured value of a sled planar of a blade server exceeds a power threshold value when the request is the shutting down signal or the resetting signal, determining whether the chassis management system encounters a system error when the power measured value of the sled planar of the blade server does not exceed the power threshold value, and shutting down or resetting the sled planar of the blade server according to a default condition when the chassis management system does not encounter the system error.

The contents of the present invention set forth and the embodiments hereinafter are for demonstrating and illustrating the spirit and principles of the present invention, and for providing further explanation of the claims.

### BRIEF DESCRIPTION OF THE DRAWINGS

The present invention will become more fully understood from the detailed description given hereinbelow and the accompanying drawings, which are given by way of illustration only and thus are not limitative of the present invention and wherein:

FIG. 1 is a diagram of a blade server in the prior art.

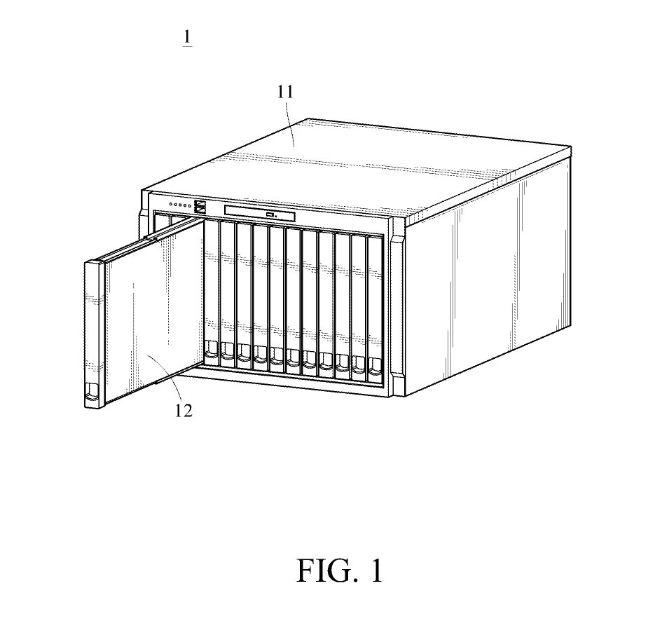

FIG. 2 is a flowchart of the method for controlling the sled planar of the blade server according to an embodiment of the present invention.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

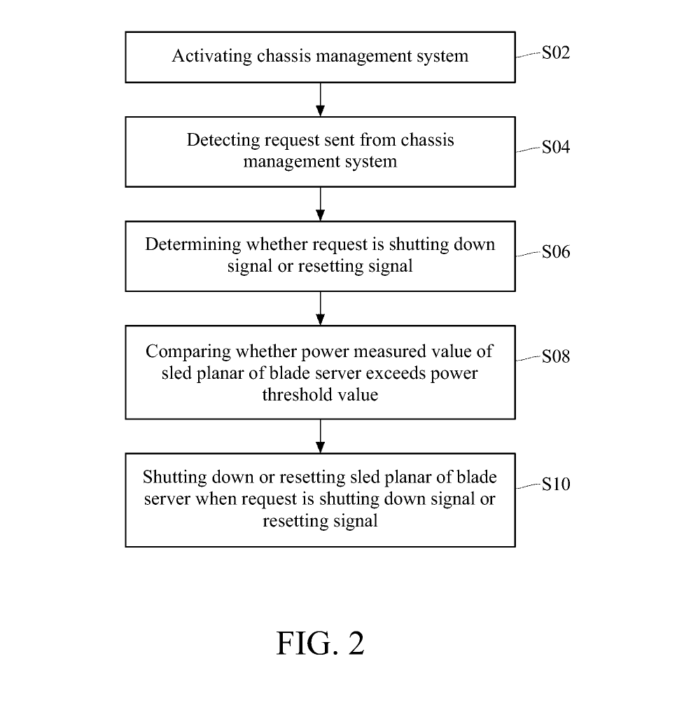

Please refer to FIG. 2. FIG. 2 is a flowchart of the method for controlling the sled planar of the blade server according to an embodiment of the present invention. In the step S02, a chassis management system is activated so that the chassis management system starts to operate. In the step S04, whether a request sent from the chassis management system is a shutting down signal or a resetting signal is determined. In the step S06, whether a power measured value of a sled planar of a blade server exceeds a power threshold value is compared. In the step S08, whether the chassis management system encounters a system error is determined.

In contrast to the prior art, when the chassis management system sends a wrong request of a shutting down signal or a resetting signal, the sled planar of the blade server is directly shut down or reset according to the wrong shutting down signal or the resetting signal. However, the method for controlling the sled planar of the blade server in the present invention compares the power of the sled planar of the blade server to determine whether the chassis management system encounters a system error. In the step S10, the chassis management system determines to shut down or reset the sled planar of the blade server according to the default condition when the chassis management system does not encounter a system error.

Furthermore, in the step S08, when the power measured value of sled planar of the blade server exceeds the power threshold value, a status flag is sent to the chassis management system for indicating that the power of the sled planar exceeds the threshold value. The threshold value is defined by the user and corresponds to the practical operation status of the sled planar. For example, the power threshold value is defined as 100 watts and a status flag is sent for indicating that the current sled planar is overloaded when the power measured value exceeds 100 watts. Therefore, the chassis management system redistributes according to the power distribution status of each sled planar of the blade server. The sled planar with less power consumption is extracted with more power to the overloaded sled planar.

As mentioned previously, when the power measured value does not exceed the power threshold value, the method detects whether the chassis management system encounters a system error. For example, the power threshold value is defined as 50 watts and the method determines whether the chassis management system needs to shut down or reset the sled planar of the blade server when the power measured value does not exceed 50 watts and the sled planar does not exceed the power threshold value with further confirmation. In other words, the method detects whether the chassis management system encounters a system error. In addition, when the power measured value of each sled planar of the blade server does not exceed the power threshold value, the chassis management system also equally distributes the power to each sled planar. Furthermore, when the chassis management system encounters a system error, a wrong shutting down signal or resetting signal is sent from the chassis management system. Therefore, the sled planar of the blade server must not be shut down or reset by the wrong shutting down signal or resetting signal, and is maintained in an operating status. Each sled planar of the blade server has a CPLD (complex programmable logic device). Therefore, the chassis management system detects the confirm message of the CPLD sent from the chassis management system to the sled planar of the blade server to determine whether the chassis management system encounters a system error. In addition, the power measured value and the power threshold value are also compared by the CPLD and recorded by the storage device.

When the chassis management system does not encounter a system error and the request sent from the chassis management system is a shutting down signal or a resetting signal, the sled planar of the blade server is confirmed to be shut down or reset according to the shutting down signal or the resetting signal. In addition, the default condition includes a temperature value of the sled planar and/or an operation status of the sled planar, and the default temperature value is compared with a reference temperature value, and the operation status represents the power or operating speed of the sled planar . . . etc. The default condition is for determining to shut down or reset the sled planar of the blade server. For example, when the chassis management system sends a request of shutting down or resetting, no matter whether the power measured value exceeds the power threshold value and whether the chassis management system encounters a system error, the chassis management system still determines whether to shut down or reset the sled planar of the blade server according to the default condition.

In summary, in addition to originally detecting the power value of each sled planar, the method for controlling the sled planar of the blade server of an embodiment distributes the power according to the amount of the power threshold value of each sled planar, so that the heavily loaded sled planar obtains more resources (power) from the less loaded sled planar. In another embodiment, the method further detects the operation status of each sled planar, so that the incorrect operations performed by the sled planar of the blade server are avoided when the chassis management system sends the wrong packets s or transmits the wrong request of shutting down or resetting.

The foregoing description has been presented for purposes of illustration. It is not exhaustive and does not limit the invention to the precise forms or embodiments disclosed. Modifications and adaptations will be apparent to those skilled in the art from consideration of the specification and practice of the disclosed embodiments of the invention. It is intended, therefore, that the specification and examples be considered as exemplary only, with a true scope and spirit of the invention being indicated by the following claims and their full scope of equivalents.

What is claimed is:

1. A method for controlling a sled planar of a blade server, comprising:
activating a chassis management system
determining whether a request sent from the chassis management system is a shutting down signal or a resetting signal;
comparing whether a power measured value of a sled planar of a blade server exceeds a power threshold value when the request is the shutting down signal or the resetting signal;
determining whether the chassis management system encounters a system error when the power measured value of the sled planar of the blade server does not exceed the power threshold value; and
shutting down or resetting the sled planar of the blade server according to a default condition when the chassis management system does not encounter the system error.

2. The method of claim 1, wherein the default condition comprises a default temperature value of the sled planar or an operation condition of the sled planar, and the default temperature value is compared with a reference temperature value to determine whether to shut down or reset the sled planar of the blade server.

3. The method of claim 1, wherein when the power measured value exceeds the power threshold value, a status flag is sent to the chassis management system, so that the chassis management system determines to shut down or reset the sled planar of the blade server according to the default condition.

4. The method of claim 1, wherein when the chassis management system encounters the system error, the blade server is maintained in an operating status.

5. The method of claim 1, wherein the power threshold value is recorded in a storage device of the sled planar.

6. The method of claim 1, wherein the power measured value and the power threshold value are compared by a complex programmable logic device (CPLD) of the sled planar.

7. The method of claim 6, wherein whether the chassis management system encounters the system error is detected based on a confirm message sent from the chassis management system to the CPLD of the sled planar of the blade server.
